(19) United States
(12) Patent Application Publication
(10) Pub. No.: US 2005/0111948 A1
(43) Pub. Date: May 26, 2005

(54) Integrated boom, tow bar and wheel lift tow truck assembly

(76) Inventors: Pablo Nolasco, Corona, NY (US); Harry Brown, Bay Shore, NY (US)

Correspondence Address: ALFRED M. WALKER, 225 OLD COUNTRY ROAD, MELVILLE, NY, 11747-2712, US

(21) Appl. No.: 10/718,367

(22) Filed: Nov. 20, 2003

(51) Int. Cl. B66C 1/00

(52) U.S. Cl. 414/563

(57) ABSTRACT

An assembly of three useful components for towing, such as a unique three stage telescopic boom, a tow bar assembly and a wheel lift assembly. The boom has a cable winch and cable for lifting and accommodating the tow bar assembly, which are both available to tow a disabled vehicle, in conjunction with the alternate wheel lift assembly operable off the rear deck of a tow truck. The tow truck wrecker has three significant towing components not combined in other tow trucks. The three necessary components organized under the present invention are always accessible and easily stored in respective positions, which minimize visual obstructions to the tow truck operator from within the cab of the tow truck wrecker. As a result of the aforementioned movements and operable capability of the three lifting component of the tow truck, the three components are movable in a synchronous manner from their respective storage positions, to their respective operable deployment positions, without interfering with movement of any of the other components.

### FIELD OF THE INVENTION

The present invention relates to tow truck accessories.

### BACKGROUND OF THE INVENTION

Because of the rearward orientation of towing components, it is difficult to accommodate and store fully assembled tow truck lifting components. For example, large booms telescope outward from the rear deck of a tow truck. At the same time wheel lifts, having telescopic probe arms and perpendicular cross bars having wheel lifting arms, are also large and cumbersome to store in conjunction with the large boom of a tow wrecker. In addition, manual implemented tow bar accessories often must be stored out of the way, such as beneath or on top of a tow truck wrecker deck, and are therefore cumbersome to move in position along the same axis of alignment, as occupied by telescopic probe arm of a wheel lift component. In order to accommodate the telescopic probe arm, having wheel lift cross bars extending therefrom, the probe arm must be retracted about a hinged joint until placed in the position of rest facing upwards and towards the cabin of the tow truck but beneath the boom, which in its normal position of storage extends upward and outward away from the cabin. In addition, the large boom and probe arm, when stored, can obstruct the view of the driver, viewing through the rear window of the tow truck cab, thus making it difficult to position the wheel lifting arms or other lifting accessories about the disabled vehicle to be towed.

### OBJECTS OF THE INVENTION

It is therefore an object of the present invention to provide a tow truck having an easily storable and engageable telescopic boom, with cable winches, accommodating easily accessible tow bars while not interfering with the alternate storage and engagement of the telescopic probe arm supporting a perpendicularly extending cross bar, having wheel lifting arms attached thereto.

It is also an object of the present invention to have an easily accessible tow bar assembly.

It is yet another object of the present invention to provide an improved viewing sight line from the rear window of a cab of a tow truck.

It is a further object of the present invention to provide both manual and remote controls which are ergonomically accessible, while operating in a plane of use which prevents injury to the operator, while the towing assemblies are being used to lift and tow a disabled vehicle.

It is a further object of the present invention to provide a cable winch hook storage, which prevents sudden quick movements of the hook, suspended freely about the cable winch.

### SUMMARY OF THE INVENTION

In keeping with these objects and others, which may become apparent, the present invention includes an assembly of three useful components for towing, such as a unique three stage telescopic boom, a tow bar assembly and a wheel lift assembly. The boom has a cable winch and cable for lifting and accommodating the tow bar assembly, which are both available to tow a disabled vehicle, in conjunction with the alternate wheel lift assembly operable off the rear deck of a tow truck.

In that manner, the tow truck wrecker of the present invention has three significant features not combined in other tow trucks. The three necessary components organized under the present invention are always accessible and easily stored in respective positions, which minimize visual obstructions to the tow truck operator from within the cab of the tow truck wrecker.

The tow bar assembly includes a pair of diverging obliquely placed extender arms, which extend from a pivot point at the rear deck of the tow truck wrecker at a proximal end of the tow bar assembly. The obliquely extending arms of the tow bar assembly include a cross bar at a distal end thereof. The distal end of the cross bar includes an access point for a tow truck chain to engage around an axle or other frame member of a disabled vehicle.

The tow bar cross bar also includes at opposite sides thereof, one sling of a pair of deck stored fabric or rubber slings, which engage around the bumper and undercarriage of the vehicle being towed, so as not to cause damage by the lifting tow bar mechanism. The slings are flexible fabric textile members, preferably nylon, which extend from the cross bar of the tow bar assembly, located at the distal end of the tow bar assembly. The other end of the cross bar assembly has a further cross bar, which is accessible by hook to a cable winch, extending operable off of the distal end of the telescopic boom of the tow truck wrecker.

When the tow bar is used, a chain or other connecting member is engageable around the undercarriage, axle or other accessible portion of the disabled vehicle, so that the nylon slings cradle and protect the delicate front or rear end of the vehicle being towed.

After the tow bar and the chain are in place, and the slings are in place around the undercarriage of the vehicle, the cable winch is engaged, pulling the tow bar up, thereby lifting the end of the vehicle off of the ground for towing the disabled vehicle.

Optionally, when a wheel lift assembly is used with a telescopic probe arm having a crossbar and wheel lifting arms at opposite ends of the cross bar, the tow bar assembly is easily placed out of the way, by pivoting it upward over a gap recess in the tow truck body deck, to a slanted ramp tow bar holding portion, which prevents rearward movement of the distal cross bar of the tow bar assembly.

Unlike prior art configurations where a tow bar assembly has to be manually moved out of the way when using a wheel lift mechanism instead, in that storage position of the tow bar assembly, there is provided a generally V-shaped recess between the obliquely extending arms of the tow bar assembly. Within that recess the pivotable probe arm of the wheel lift mechanism is movable during various stages of operation and/or storage, so that a lower portion of the probe arm will extend into the recess provided between the obliquely extending arms of the tow bar assembly.

Likewise, when the wheel lift assembly is no longer in use and it is pivoted back in place of storage, it then pivots and rests in a position extending upward and forward, towards the cab, in the same plane as the stored tow bar that's spaced apart from the tow bar.

The recess cut into the rear deck of the tow truck wrecker vehicle is wide and deep enough to accommodate portions of the oblique tow bar extension arms and portions of the telescopic probe arm of the wheel lift mechanism, in respective storage and operable positions, which minimize any visual obstructions, and provide an improved visual sight line from the cab for the operator of the tow truck.

When the probe arm and wheel lift assembly is used, the wheel lifting arms may automatically rotate around and engage the tires. However, in order to prevent blow outs of the tires, there are sensors provided so that they stop forward movement at a predetermined hydraulic pressure, to prevent excess continuing pressure against the tires of the vehicle being towed.

In addition, in order to prevent injury to the operator of the tow truck, the lifting mechanisms can alternatively be remotely operated outside of the cab, from within the cabin, or from a remote connectable cable, such as a coil cable, outside the cab. However, in addition, the lifting assemblies can also be operated by controls located at the side of the rear deck of the tow truck. In that case, there is provided enough clearance from movement of the laterally extending cross bar of the wheel lift out of any plane of placement of the operator's body, to prevent injury to the operator of the tow truck's towing mechanisms.

Also, when the freely movable hook from the cable winch, which engages the distal end of the tow bar, is not in use, it is held in a storage position by coil spring loaded member, which allows a snug but safe minimal movement of the hook during movement.

As a result of the aforementioned movements and operable capability of the three lifting component of the tow truck, the three components are movable in a synchronous manner from their respective storage positions, to their respective operable positions without interfering with movement of any of the other components.

### BRIEF DESCRIPTION OF THE DRAWINGS

The present invention can best be understood in connection with the accompanying drawings in which:

FIG. 1A is a perspective view of the rear of a tow truck wrecker with its lifting assembly components, shown in its compact storage position;

FIG. 1B is a perspective view of the rear of a tow truck wrecker with its tow bar lifting assembly components, shown in an outward deployed position;

FIG. 2 is a side elevational view of the lifting components of the tow truck wrecker of the present invention shown at rest;

FIG. 3 is a side elevational view thereof showing the boom in the unique upward position;

FIG. 4 is a side elevational view showing the tow bar lifting assembly components of the present invention, wherein the boom and cable are shown rotating the tow bar into a position of use, as the boom rotates down and extends telescopically rearward;

FIG. 5 shows the tow bar and boom down and extended with a hook engageable with the tow bar;

FIG. 6 is a close-up detail perspective view of the tow bar lifting mechanism as in FIGS. 2, 3, 4 and 5, taken in the dashed line area “6” of FIG. 2, wherein a portion of the tow bar lifting mechanism is shown in a storage position, and showing the recess gap between the extender arms thereof;

FIG. 7 is a side elevational view showing the three stage telescopic boom supporting a cable winch hook engageable with a tow bar hauling a disabled vehicle;

FIG. 8 is a side elevational view of the wheel lift assembly being deployed;

FIG. 9 is a side elevational view showing the wheel lift engaged in an outward position of engagement;

FIG. 10 is a side elevational view showing the location of the towing components rear of the cab with dimensions and clearances provided by the towing components, to prevent injury to the operator, when the operator manually uses the hand controls upon the deck of the tow truck;

FIG. 11 is a rear perspective view showing the optional remote controls of the present invention;

FIG. 12 is a top plan view of a pair of wheel lifting arms of the wheel lift mechanism engagable with two tires of disabled vehicle being towed;

FIG. 13 is a side elevational view showing the visual sight line provided from within the cab of the tow truck wrecker, when the operator is viewing rearward towards the disabled vehicle, wherein the upper line shows the limited sight view of the prior art and the lower line shows the visual sight line of the present invention; and,

FIGS. 14 and 15 are close-up detail views, taken along the dashed line “14” of FIG. 2, which show a cable winch hook storage member having a movement limiting spring, which provides for safety of the user of the tow truck.

### DETAILED DESCRIPTION OF THE EMBODIMENTS

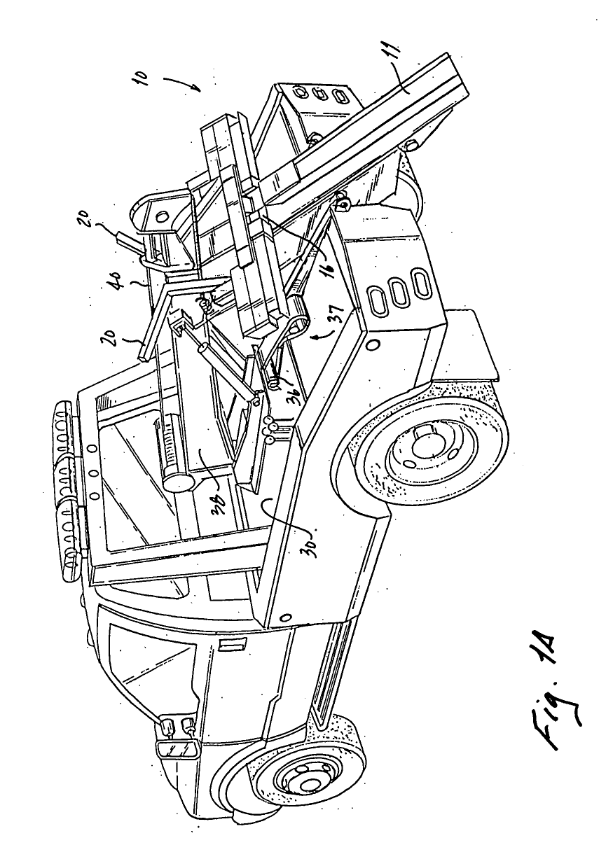

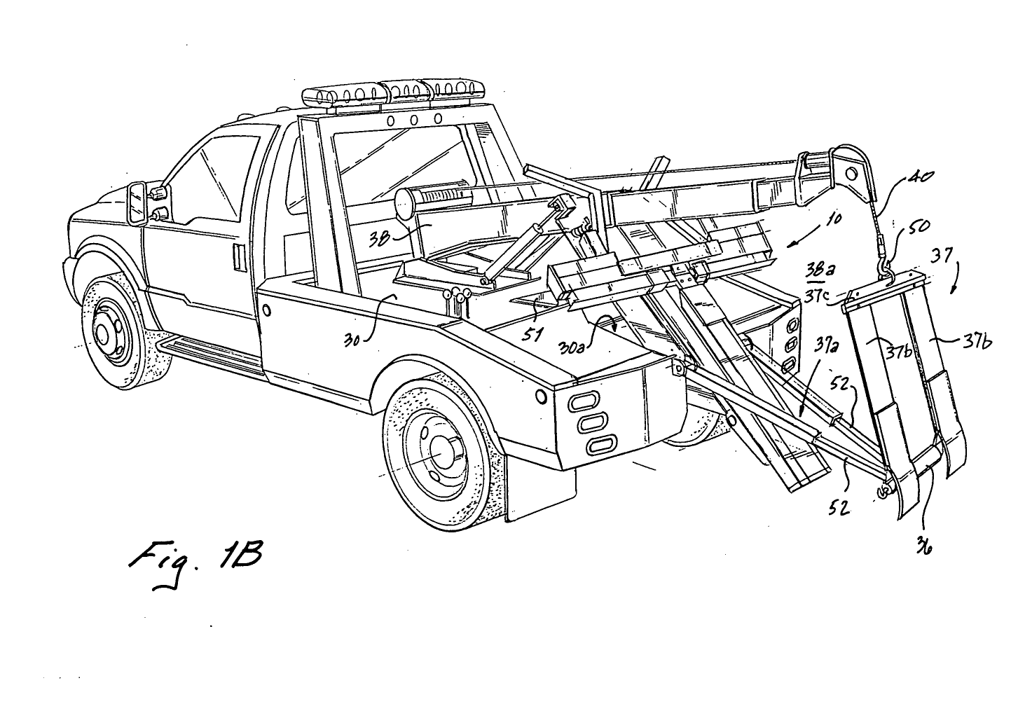

Shown in the perspective view of FIGS. 1A and 1B, a tow truck wrecker includes a rear deck 30 supporting a three stage telescopic boom 38, having a lifting winch cable 40 supported thereby, wherein the winch cable 40 engages and lifts a tow bar and sling apparatus 37. A recess 38a is provided beneath boom 38 and above rear deck 30 of the tow truck. The tow bar and sling apparatus 37 includes an outer cross tow bar 36 at one end and a swivel knuckle assembly connected at an opposite end to a rear edge of deck 30 of the tow truck. The outer tow bar 36 is connected to the rear deck-mounted knuckle assembly by a pair of obliquely extending arms 52, which provide a generally truncated triangular recess 37a therebetween. The tow bar and sling assembly 37 also includes a pair of flexible vehicle lifting slings 37b attached at one end to tow bar 36 and at the other end to a further cross member 37c, having a slot or hole therein, accommodating a lifting hook 50, attached to the cable 40, which is supported by boom 38 of the tow truck. When the tow bar 36 is attached to a portion of the disabled vehicle to be towed, slings 37b wrap under and protect the bumper thereof, as shown in FIG. 7.

Also shown in FIGS. 1A and 1B is a wheel lift mechanism 10, including a probe arm assembly 11, extending rearward from the deck of the tow truck wrecker, wherein the probe arm 11 has a cross bar 16 at a distal end thereof with a pair of opposite slider arms having laterally and pivotably movable wheel lifting arms 20 attached thereto.

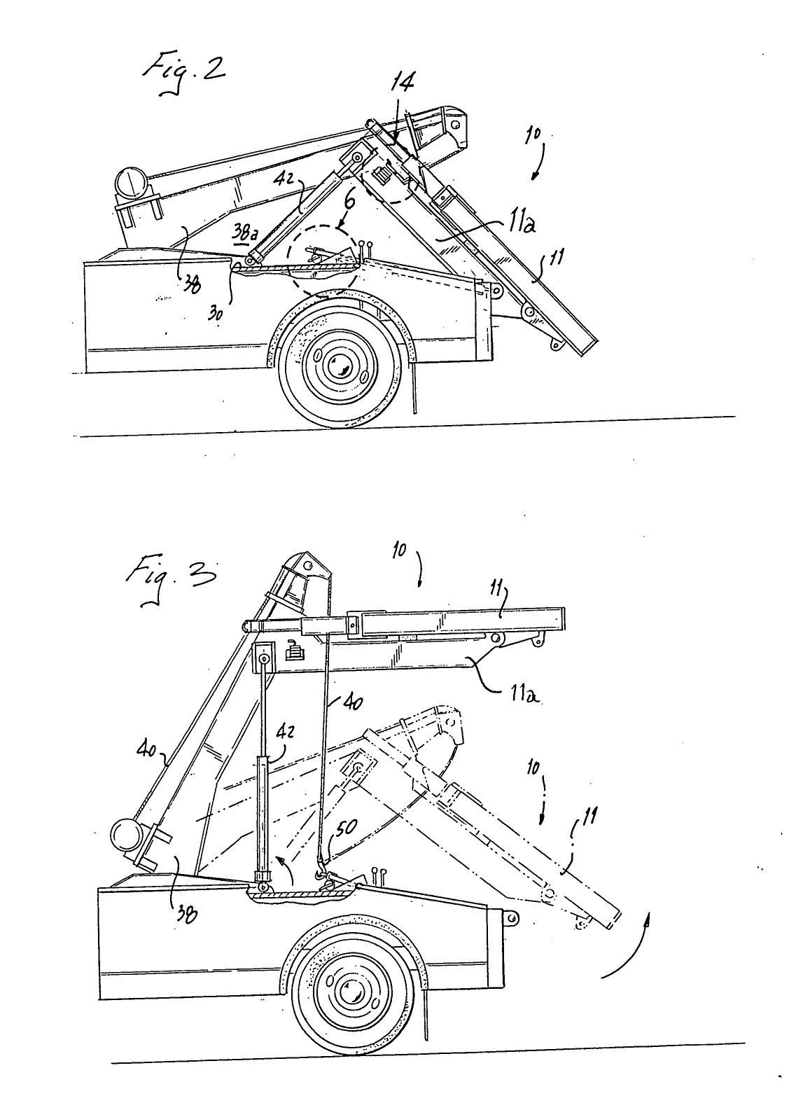

As shown in FIGS. 2 and 3, the distal end of probe arm 11 includes a pair of wheel lifting arms 20, and the proximal end of probe arm 11 is pivotably attached to a distal end of intermediate probe extender arm 11a cantilevered off of boom 38. Intermediate probe extender arm 11a is attached at its proximal end to boom 38 in the vicinity of the piston of extra large hydraulic cylinder 42, the long length of which is needed to move the boom 38 upward during movement of probe arm 11 in the recess 38a beneath probe arm 38.

The wheel lift assembly 10 also operates off of the deck behind the cab of the tow truck wrecker.

FIGS. 2-8 show various elevations of deployment of the accessible tow bar, boom 38 and wheel lift 11 of the present invention. The extra long cylinders 42 maximize boom 38's elevation, to allow for the movement of the probe arm of wheel lift mechanism 10 to pivot thereunder.

For example, FIG. 2 shows the tow bar 36 and wheel lift assembly 10 with probe arm 11 at rest, where the probe arm 11 rests beneath the boom 38, while the outer wheel lifting claw arms 20 of wheel lift mechanism 10 straddle the boom 38.

FIG. 3 shows the boom 38 in an up position to provide clearance for storing the tow bar 36 assembly.

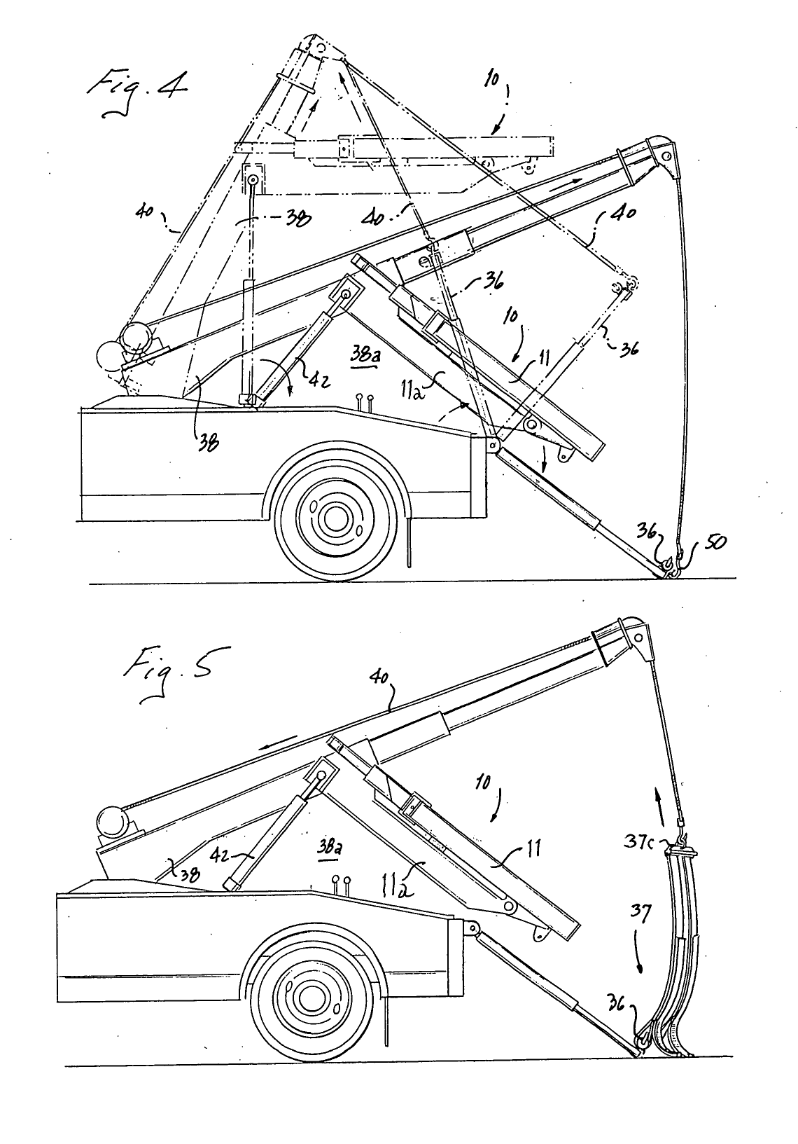

In FIG. 4, the side elevational view shows the tow bar 36 rolling into position from the rear of the truck, and supported by the winch cable 40 attachable to the extended boom 38.

FIG. 5 is a side elevational view showing movement of the tow bar and the boom 38 downward, wherein the boom 38 is extended with a cable winch hook attached to a tow bar.

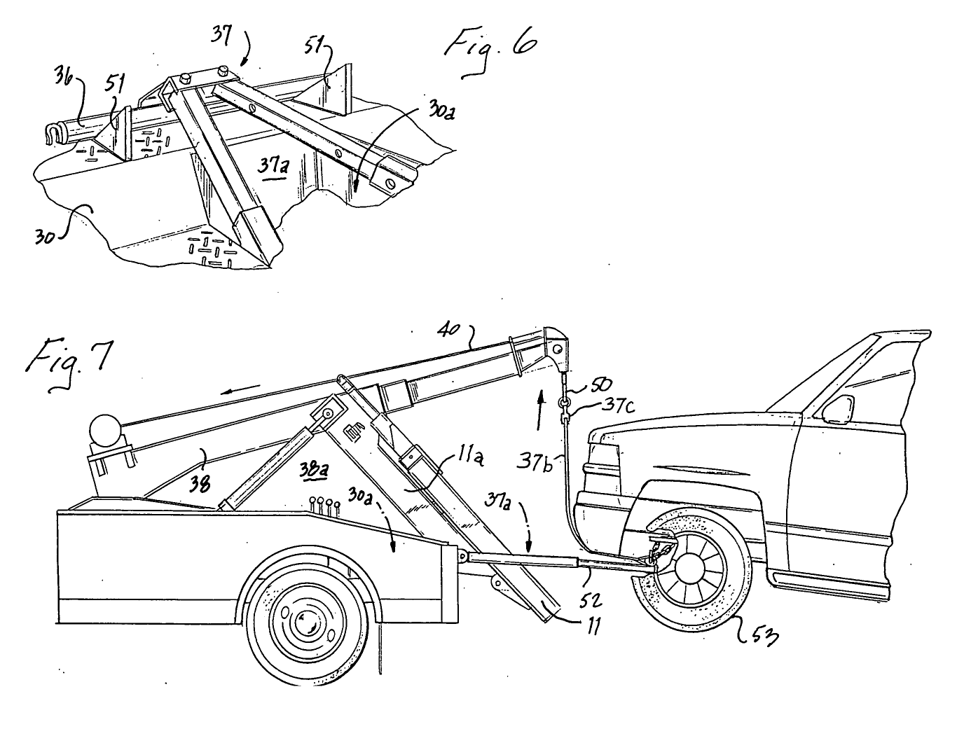

FIG. 6 shows a portion of the tow bar lifting mechanism 37 in a storage position, wherein the distal end of the tow bar is held in place adjacent to upwardly slanted holding ramps 51 attached to the deck 30 of the tow truck. FIG. 6 also shows the recess gap 37a between the extender arms 52 which connect the tow bar 36 of the tow bar assembly 37 to the rear edge of the deck 30 of the tow truck. Recess gap 37 is wide enough to accommodate a portion of the probe arm 11 of wheel lift mechanism 10 therein, as shown in FIG. 7. In that manner, when the tow bar assembly 37 is stored at deck 30 with tow bar 36 placed adjacent to slanted ramps 51, or is deployed outward from the rear of deck 30, the probe arm assembly 11 of wheel lift mechanism 10 can freely rotate, from its outward deployed position, to its compact stored position beneath boom 38, without interfering with the deployment of tow bar and sling apparatus 37 off of deck 30 of the tow truck.

As shown in FIG. 7, respective lower portions of the probe arm 11 and the intermediate probe extender arm 11a are positioned within the recess gap 37a provided between the extender arms 52 of the tow bar assembly 37, when tow bar assembly 37 is used, instead of the stored wheel lift mechanism 10, to tow a disabled vehicle.

FIG. 7 also shows the boom 38 down in a low profile.

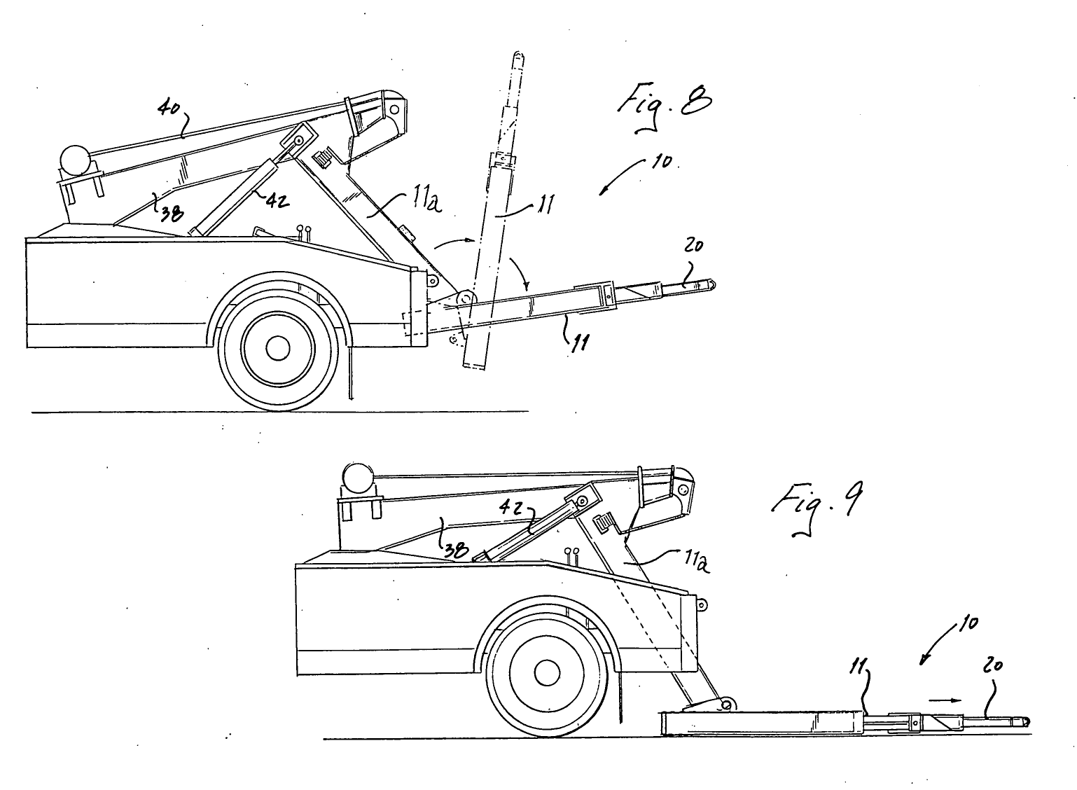

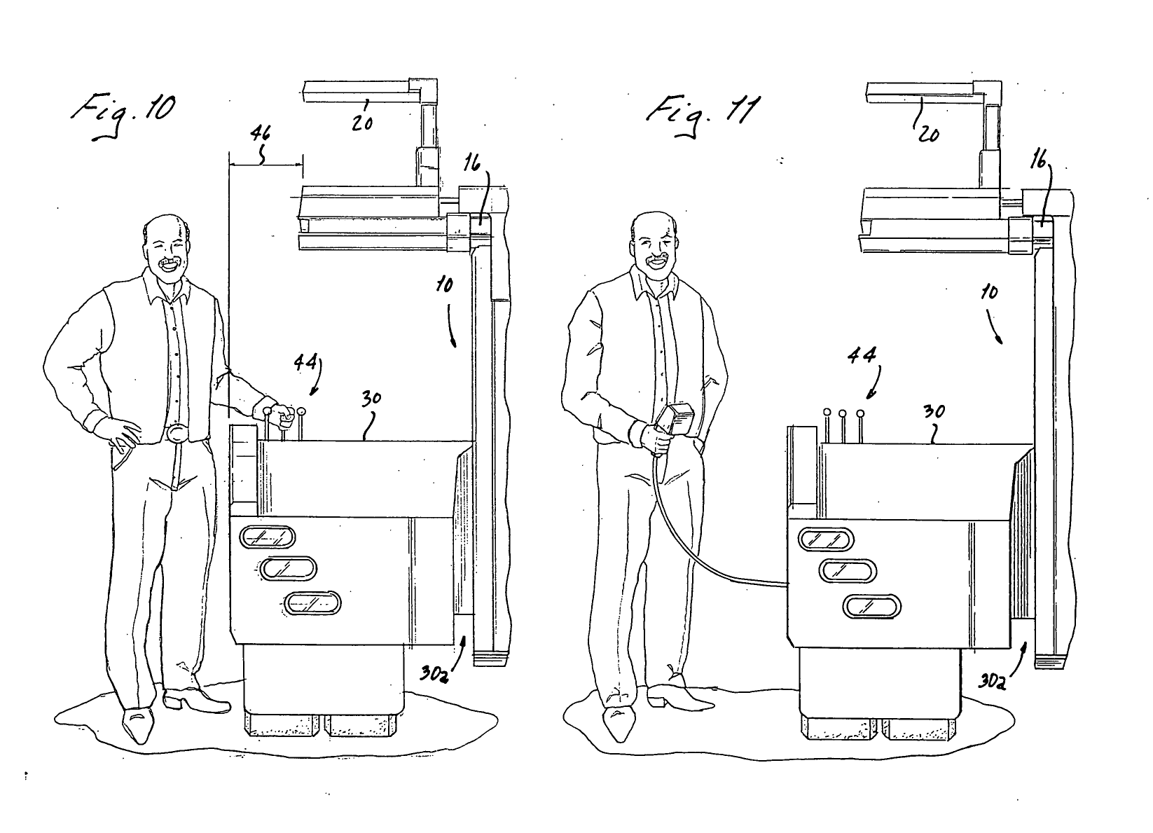

When the tow bar assembly 37 shown deployed in FIGS. 1B and 4-7 is not used, FIGS. 8 and 9 show the optional deployment of wheel lift mechanism 10, wherein the phantom lines of FIG. 8 show the wheel lift mechanism 10 being moved, out of the storage position beneath boom 38 in FIG. 7, toward the low profile outward deployment position shown in FIG. 9.

FIG. 9 is a rear perspective view showing the wheel lift 10 in an outward extended position off of the probe arm 11 of the tow truck vehicle.

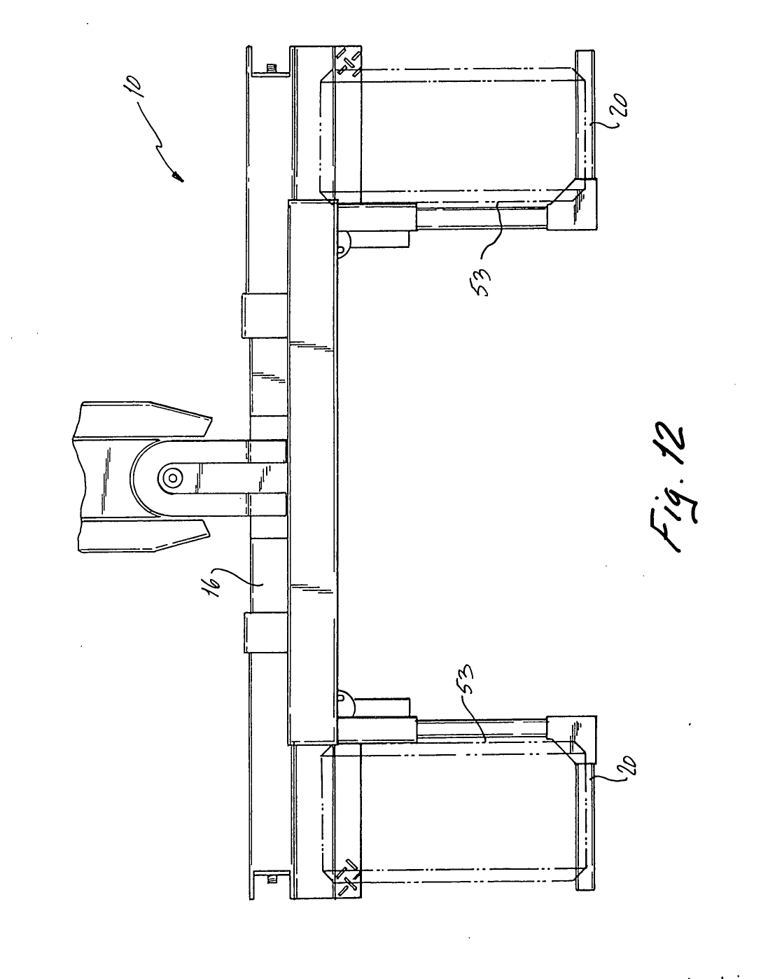

FIGS. 10 and 11 show alternate manual and remote operation of the controls for the lifting mechanisms of the present invention, wherein FIG. 10 shows that the movement of the cross bar 16 and wheel lifting arms 20 of the wheel lift towing accessories is outside the plane of the position of the operator adjacent to the tow truck deck, so that the operator is not hurt by a moving component when the operator manually uses controls 44 upon the deck 30 of the tow truck.

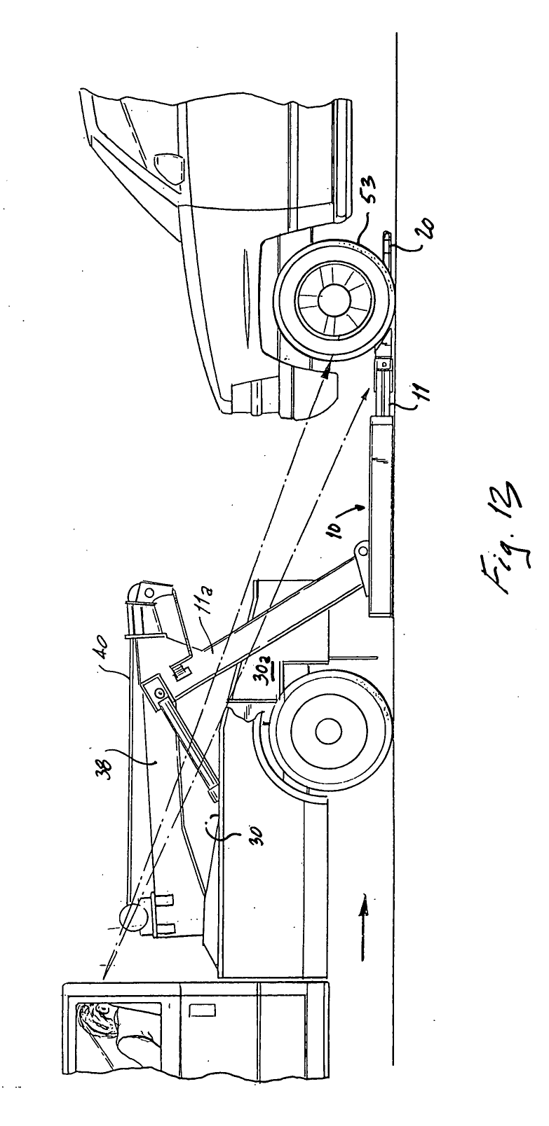

FIG. 12 is a top plan view showing the engagement of the wheel lifting arms 20 of wheel lift mechanism 10 against the tires 53 of the disabled vehicle.

FIG. 13 further shows an ergonomic feature of an increased sight line visibility, through the rear window of the tow truck, because of the synchronous placement of the various lifting assemblies in alternate storage and positions of operation improved visibility, wherein the recess of the deck is wide enough and low enough to provide a view from the rear window of the wheel lift assembly at respective tires of a disabled vehicle.

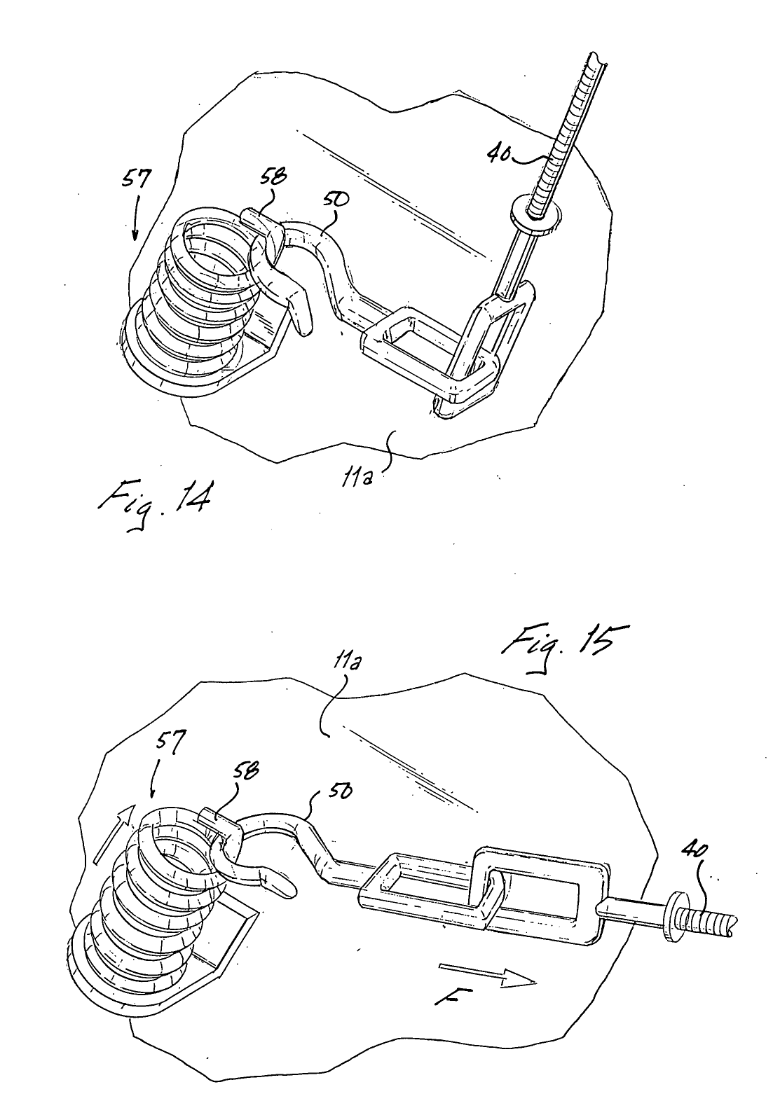

FIGS. 14 and 15 show the hook 50 storage into the spring 57 component, with loop 58 which allows for safe but resilient storage of the hook of the cable winch and stored away.

The conformability of the various subsystem components to each other and to tow truck 1 is seen in several of the Figures. For example, recess 30a in deck 30 is most visible in FIGS. 1A, 1B and 2. This space provided by recess 30a is partly occupied by wheel lift probe arm 11 in both its storage and deployed positions. The proximal ends of the extender arms 52 of tow bar assembly 37 are hinged at a top edge of recess 30a (toward the rear of the recess 30a); tow bar assembly 37, with tow bar 36 at its distal end, is stored by folding it forward partially within recess 30a. Recess 37a, within the frame of tow bar assembly 37, provides the clearance required by wheel lift probe arm 11 in its folded storage position. Recess 38a under telescoping boom 38, clearly visible in FIGS. 2 through 7, provides storage space for both folded tow bar assembly 37 as well as wheel lift assembly 10 when these latter two subsystems are not in use.

As a result of the foregoing, the tow truck wrecker of the present invention, provides three main towing components, namely the 3 stage telescopic boom, the tow bar assembly supported by the boom and the laterally and pivotably movable slider arms of the slider arm assembly. All three components operate synchronously within the respective planes of storage and movement of the other components, so that each component is stored efficiently with minimal obstruction to the sight line of the operator located in the cab of the tow truck wrecker. Each component rests in a storage position, without interfering in movement or deployment of each and every one of the three lifting assembly components of the tow truck wrecker.

It is further know that other modifications may be made to the present invention without departing from the scope of the invention as noted in the appended Claims.

1. An arrangement of a stored set of accessories of a tow truck, comprising:
a telescopic boom;
a tow bar assembly having a pair of oblique extender arms, namely a right extender arm and a left extender arm, said extender arms connected at a tow bar and defining a recess; therebetween;
a wheel lift assembly having a rearwardly extending probe arm supporting a transverse cross bar having a pair of rotatable, laterally movable wheel lifting scoops;
said tow truck comprising a deck having a second recess and a distal end, said second recess extending inward from said distal end of said deck substantially at the midpoint of said distal end of said deck;
said second recess having a right edge and a left edge;
said right extender arm non-removably rotatably attached adjacent to an upper portion of said right edge of said second recess and said left extender arm non-removably rotatably attached adjacent to an upper portion of said left edge of said second recess.

2. The arrangement as in claim 1, wherein said telescopic boom comprises three stages.

3. The arrangement as in claim 1 wherein said second recess comprises a substantially V-shaped recess;

4. The arrangement as in claim 1, wherein said second recess comprises a substantially truncated V-shaped recess.

5. The arrangement as in claim 1 further comprising a third recess extending downward through a portion of said deck, wherein a portion of said probe arm of said wheel lift assembly lies within said third recess.

6. An arrangement of a stored set of accessories of a tow truck, comprising:
a telescopic boom;
a tow bar assembly having a pair of oblique extender arms, namely a right extender arm and a left extender arm, said extender arms connected at a tow bar joint and defining a first recess therebetween;
a wheel-lift assembly, a portion of said wheel-lift assembly situated within said recess;
said tow truck comprising a deck having a second recess and a distal end, said second recess extending inward from said distal end of said deck substantially at the midpoint of said distal end of said deck;
said second recess having a right edge and a left edge;
said right extender arm non-removably rotatably attached adjacent to an upper portion of said right edge of said second recess and said left extender arm non-removably rotatably attached adjacent to an upper portion of said left edge of said second recess.

7. The arrangement as in claim 1, wherein said deck further comprises a tow bar holding portion, said holding portion comprising a slanted ramp and locking means, said tow bar removably lockable with said holding portion for storing said tow bar.

8. The arrangement as in claim 5, wherein said probe arm of said wheel lift assembly includes a first portion of said probe arm extending into said first recess, a second portion of said probe arm extending into said second recess and a third portion of said probe arm extending into said third recess.

9. An arrangement as in claim 6, wherein said wheel-lifting assembly further comprises a top surface being the uppermost portion of said wheel-lifting assembly, as in said arrangement, and said towing truck comprises a rear window having a top edge and an opposing bottom edge, the height of said top surface of said wheel-lifting assembly being lower than the height of said bottom surface of said rear window for improved visibility, and said second recess of said deck being wide enough and low enough to provide a view from said rear window of said wheel lift assembly at respective tires of a disabled vehicle.

10. A method of lifting one end of a four-wheeled vehicle by a tow truck, comprising a plurality of steps, controlled by a user operating a remotely controlled means, said steps comprising:
i) lowering an end of a wheel-lifting assembly adjacent to an end of said vehicle to be lifted, said end of said wheel-lifting assembly having a cross bar, said cross bar having a pair of slider arms extending outwardly from said end of said wheel-lifting assembly;
ii) telescoping said wheel-lifting assembly outward, each said slider arm comprising a claw pivotally mounted at one end of said slider arm using at least one hydraulic cylinder for alignment with the wheels of said vehicle to be towed;
iii) advancing each said slider arm toward adjacent wheels of said vehicle to be towed;
iv) pivoting said claws of said slider arms to rotatably align with the wheels of said vehicle to be towed using a mechanical pivoting means;
v) terminating advancement of said slider arms, under the condition of each said slider arm contacting a wheel of said vehicle to be towed;
vi) using at least one hydraulic cylinder, retracting said slider arms until said claws make contact with sides of said adjacent wheels opposite the sides contacted by said slider arms; and
vii) raising said wheel-lifting assembly to lift one end of said vehicle to be towed.

11. The method of lifting one end of a four-wheeled vehicle as in claim 10, wherein said remote controlled means comprises a function panel and a coil cable, operable by a user located outside of a towing truck.

12. The method of lifting one end of a four-wheeled vehicle as in claim 10, the user located within the cab of a towing truck, said remote controlled means comprising a function panel located within the cab of said towing truck.

13. The method of lifting one end of a four-wheeled vehicle as in claim 10, said user operating said function panel adjacent to said deck, wherein a clearance is provided between a vertical axis of said user and the plane of movement of said cross bar of said wheel lift assembly.

14. An arrangement of a stored set of accessories of a tow truck, comprising:
a telescopic boom; said telescopic boom having a recess extending between said telescopic boom and a deck of said tow truck,
a tow bar assembly having a pair of oblique extender arms, namely a right extender arm and a left extender arm, said extender arms connected at a tow bar and defining a recess;
a wheel lift assembly;
said recess of said deck of said tow truck extending inward from said distal end of said deck substantially at the midpoint of said distal end of said deck;
said second recess having a right edge and a left edge;
said right extender arm non-removably rotatably attached adjacent to an upper portion of said right edge of said second recess and said left extender arm non-removably rotatably attached adjacent to an upper portion of said left edge of said second recess;
said recess of said deck being partly occupied by said wheel lift probe arm in both its storage and deployed positions;
respective proximal ends of said extender arms of said tow bar assembly being hinged adjacent said recess of said deck toward the rear of said recess;
said tow bar assembly having said tow bar at its distal end being stored by folding said tow bar assembly forward over said recess of said deck;
said recess of said tow bar assembly providing clearance required by said wheel lift probe arm in its folded storage position; and,
said recess under said telescoping boom providing storage space for both said folded tow bar assembly and said wheel lift assembly when said tow bar assembly and said wheel lift assembly are not in use.
